(19) United States
(12) Patent Application Publication
(10) Pub. No.: US 2020/0180912 A1
(43) Pub. Date: Jun. 11, 2020

(54) LIFTING ASSEMBLY, JUMP ELEVATOR AND JUMPING METHOD

(71) Applicant: Otis Elevator Company, Farmington, CT (US)

(72) Inventors: Bing Li, Shanghai (CN); Mingming Jiang, Shanghai (CN)

(21) Appl. No.: 16/709,433

(22) Filed: Dec. 10, 2019

(30) Foreign Application Priority Data
Dec. 11, 2018 (CN) 201811509788.3

(51) Int. Cl. B66B 9/02; B66B 11/04

(52) U.S. Cl. CPC B66B 9/025; B66B 11/0446

(57) ABSTRACT

A lifting assembly, a jump elevator and a jumping method. Wherein the lifting assembly comprises: a supporting platform provided with a plurality of telescopic first pawls at the side face thereof; at least one screw mechanism comprising a screw and a sleeve, the screw and the sleeve each being provided with an external thread and an internal thread matching with each other; and a driving mechanism configured to drive one of the screw and the sleeve to rotate in relative to the other, such that the screw mechanism extends or retracts; wherein the screw mechanism is connected between the supporting platform and the operating platform, one of the screw and the sleeve is configured to be rotatably attached to one of the supporting platform or the operating platform.

### FOREIGN PRIORITY

This application claims priority to Chinese Patent Application No. 201811509788.3 filed Dec. 11, 2018, and all the benefits accruing therefrom under 35 U.S.C. § 119, the contents of which in its entirety are herein incorporated by reference.

### FIELD OF THE INVENTION

The present application relates to the field of lifting structure for jump elevator. More specifically, the present application relates to a lifting assembly for a jump elevator for selectively applying force to a machine room of the jump elevator and lifting the jump elevator. The present application further relates to a jump elevator comprising the aforementioned lifting assembly and a jumping method for the jump elevator.

### BACKGROUND OF THE INVENTION

Jump elevators are commonly used during the construction of buildings, wherein the height of the machine room needs to be gradually increased as the height of building construction continuously increases. Therefore, a lifting device needs to be arranged inside or outside the jump elevator to selectively lift the machine room.

Existing lifting devices include lifting devices driving by hydraulic force. Hydraulic devices typically include a container for holding working fluid and an apparatus for pumping the working fluid, such as a pipe, a pump, and the like. These devices need to occupy certain space, and there is also a possibility of working fluid leakage.

Therefore, there is continuous need for a new lifting assembly, a jump elevator, and a jumping method. It is desired that such solution could further improve the structural and operational performance of the jump elevator.

### SUMMARY OF THE INVENTION

One object of the present application is to provide a lifting assembly that is capable of applying an external force to a jump elevator to push the jump elevator to a desired position and fix the jump elevator in that position. Another object of the present application is to provide a jump elevator comprising the aforementioned lifting assembly, and to provide a jumping method for the jump elevator.

The object of the present application is achieved by the following technical solutions: A lifting assembly for a jump elevator comprises: A supporting platform provided with a plurality of telescopic first pawls at the side face thereof; At least one screw mechanism comprising a screw and a sleeve, the screw and the sleeve are provided with an external thread and an internal thread matching with each other, respectively; A driving mechanism configured to drive one of the screw and the sleeve to rotate relative to the other, such that the screw mechanism extends or retracts; Wherein the screw mechanism is connected between the supporting platform and the operating platform, one of the screw and the sleeve is configured to be rotatably attached to one of the supporting platform or the operating platform.

In the lifting assembly described above, optionally, the other of the screw and the sleeve is configured to be fixed to the other of the supporting platform or the operating platform.

In the lifting assembly described above, optionally, a plurality of screw mechanisms are disposed along the perimeter of the supporting platform and the operating platform.

In the lifting assembly described above, optionally, a plurality of telescopic second pawls are disposed at the side face of the operating platform.

In the lifting assembly described above, optionally, the size and position of the first and second pawls are configured to fit with apertures on the inner wall of a hoistway, such that the first and second pawls are moveable into the apertures.

In the lifting assembly described above, optionally, the screw and the sleeve are sized that at least when the screw mechanisms are at the maximum extending length, the supporting platform or the operating platform can be lifted to a height that enables the first pawl or the second pawl to fit with apertures at higher position.

In the lifting assembly described above, optionally, the supporting platform is disposed below the operating platform.

In the lifting assembly described above, optionally, a plurality of screw mechanisms are disposed perpendicular to the top surface of the supporting platform and the bottom surface of the operating platform.

In the lifting assembly described above, optionally, the driving mechanism comprises a motor and a transmission mechanism, wherein the motor selectively extends or retracts the screw mechanism through the transmission mechanism.

In the lifting assembly described above, optionally, the motor is disposed on one of the supporting platform or the operating platform.

In the lifting assembly described above, the transmission mechanism comprises a belt transmission mechanism, a gear transmission mechanism, and/or a rack transmission mechanism.

In the lifting assembly described above, optionally, the transmission mechanism is configured to cause the plurality of screw mechanisms to extend or retract synchronously.

In the lifting assembly described above, optionally, the operating platform comprises a working platform, a machine room platform, and/or a storage compartment platform.

A jump elevator comprising the lifting assembly described above.

A jumping method for a jump elevator, comprising the steps of: S1: retracting a plurality of pawls of an operating platform from a first set of apertures on the inner wall of a hoistway, so that the operating platform is movable within the hoistway; S2: extending a screw mechanism so as to lift the operating platform to a height that enables the plurality of pawls of the operating platform to fit with a second set of apertures on the inner wall of the hoistway; S3: extending a plurality of pawls of the operating platform and fit into the second set of apertures; S4: retracting a plurality of pawls of a supporting platform from a third set of apertures on the inner wall of the hoistway, so that the supporting platform is movable within the hoistway; S5: retracting the screw mechanism so as to lift the supporting platform to a height that enables pawls of the supporting platform to fit with a fourth set of apertures on the inner wall of the hoistway; and S6: extending the pawls of the supporting platform and fitting them into the fourth set of apertures; Wherein the supporting platform is disposed below the operating platform, and the screw mechanism is connected between the supporting platform and the operating platform.

In the jumping method described above, optionally, the first set of apertures and the fourth set of apertures are the same set of apertures.

In the jumping method described above, optionally, the distance between the fourth set of apertures and the third set of apertures in the vertical direction is greater than or equal to the height of a single floor.

A jumping method for a jump elevator, comprising the steps of: S1: retracting a plurality of pawls of a supporting platform from a first set of apertures on the inner wall of a hoistway, so that the supporting platform is movable within the hoistway; S2: extending a screw mechanism so as to lift the supporting platform to a height that enables the plurality of pawls of the supporting platform to fit with a second set of apertures on the inner wall of the hoistway; S3: extending the plurality of pawls of the supporting platform and fitting them into the second set of apertures; S4: retracting a plurality of pawls of an operating platform from a third set of apertures on the inner wall of the hoistway, so that the operating platform is movable within the hoistway; S5: retracting the screw mechanism so as to lift the operating platform to a height that enables pawls of the operating platform to fit with a fourth set of apertures on the inner wall of the hoistway; and S6: extending pawls of the operating platform and fitting them into the fourth set of apertures; Wherein the operating platform is disposed below the supporting platform and the screw mechanism is connected between the supporting platform and the operating platform.

In the jumping method described above, optionally, the first set of apertures and the fourth set of apertures are the same set of apertures.

In the jumping method described above, optionally, the distance between the fourth set of apertures and the third set of apertures in the vertical direction is greater than or equal to the height of a single floor.

The lifting assembly, jump elevator and jumping method of the present application have the advantages of being simple in structure, easy to manufacture, convenient to use and the like, and can conveniently move the jump elevator into the desired position and fix it in place.

### BRIEF DESCRIPTION OF THE DRAWINGS

The present application will be described in further detail below in conjunction with the accompanying drawings and the preferred embodiments, but those skilled in the art will appreciate that the drawings are depicted for the purpose of illustrating the preferred embodiments only and therefore shall not be taken as limiting the scope of the present application. In addition, unless specifically noted, the drawings are only intended to conceptually represent the composition or configuration of the described objects and may contain exaggerated display, and the drawings are not necessarily drawn in scale.

FIG. 1 is a schematic structure view of one embodiment of a jump elevator of the present application.

### DETAILED DESCRIPTION OF THE EMBODIMENT(S) OF THE INVENTION

Preferred embodiments of the present application will be described in details below with reference to the accompanying drawings. It will be appreciated by those skilled in the art that these descriptions are merely descriptive, exemplary, and should not be construed as limiting the protective scope of the present application.

Firstly, it should be noted that the top, bottom, upward, downward, and similar orientation terms referred to herein are defined in relative to the directions in the various figures, which are relative concepts, and thus can vary according to the different locations in which they are located and the different utility states. Accordingly, these or other orientation terms are not to be construed as restrictive terms.

Furthermore, it should also be noted that any single technical feature described or implied in the embodiments herein, or any single technical feature shown or implied in the drawings can still be continuously combined between these technical features (or equivalents thereof), resulting in other embodiments of the present application not directly mentioned herein.

It should be noted that like reference numerals refer to the same or substantially the same assemblies in different drawings.

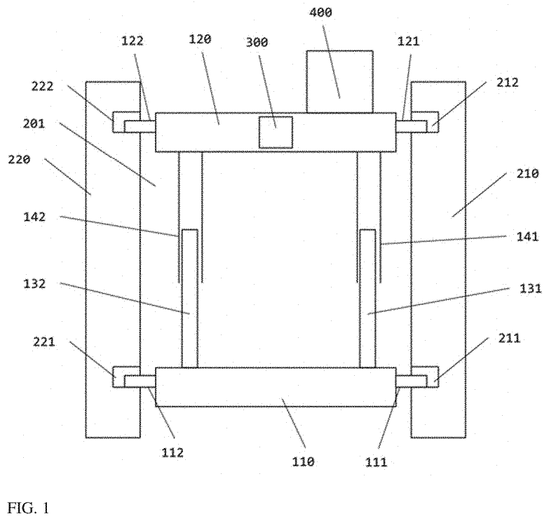

FIG. 1 is a schematic structure view of one embodiment of a jump elevator of the present application. Wherein the present application provides a lifting assembly for a jump elevator, the lifting assembly comprises: a supporting platform provided with a plurality of telescopic first pawls disposed at the side face of the supporting platform; at least one screw mechanism comprising a screw and a sleeve, the screw and the sleeve are each provided with an external thread and an internal thread matching with each other; and a driving mechanism configured to drive one of the screw and the sleeve to rotate in relative to the other, such that the screw mechanism extends or retracts; wherein the screw mechanism is connected between the supporting platform and the operating platform, and one of the screw and the sleeve is configured to be rotatably attached to one of the supporting platform or the operating platform.

It is readily understood that the jump elevator typically includes a plurality of platforms, for example a work platform for a person to stand, a machine room platform for housing a tractor, a storage compartment platform for housing a steel wire rope, and the like. The embodiment of FIG. 1 illustrates the case in which the supporting platform 110 is disposed below the operating platform 120. Wherein the operating platform 120 may include a machine room platform for housing the tractor 400 and other platforms located above the machine room platform, and the like. In fact, other platforms may be disposed below the supporting platform 110. In another embodiment, the supporting platform may be disposed above the operating platform, and the operating platform may include a machine room platform for housing the tractor and other platforms located above the machine room platform, and the like. It will be readily understood that other platforms may also be disposed above the supporting platform at this point. In the following, the working principles of the technical solutions in the present application will be illustrated primarily with reference to the embodiments in FIG. 1, but it will be readily understood that the embodiments in FIG. 1 do not preclude the existence of other cases as described above, and the present application is intended to cover such modifications and changes.

In the exemplary embodiment of FIG. 1, the supporting platform 110 is located below the operating platform 120. FIG. 1 also shows that two screw mechanisms are connected between the supporting platform 110 and the operating platform 120, including screws 131 and 132 and sleeves 141 and 142, respectively. Wherein, the screws 131 and 132 are attached to the supporting platform 110 and the sleeves 141 and 142 are attached to the operating platform 120. However, the arrangement in the figure is illustrative only, and in fact, the screw may be attached to the operating platform, and the sleeve may be attached to the supporting platform and still achieve the same effect.

In order for the screw mechanism to be extended and retracted, each screw and sleeve are sized to being able to match with each other, and the outer circumference of each screw is provided with external threads, the inner circumference of each sleeve is provided with internal threads, the external threads and the internal threads are configured to match in size, so that the screw mechanism can provide secured connection between the supporting platform and the operating platform. One of the screw and the sleeve is configured to be rotatable in relative to one of the supporting platform and the operating platform, and the other of the screw and sleeve is configured to be fixed in relative to the other of the supporting platform and the operating platform. In the embodiment shown in FIG. 1, the sleeves 141 and 142 attached to the operating platform 120 may be configured to be rotatable about their own axes with respect to the operating platform 120. However, according to actual requirement, the screws 131 and 132 attached to the supporting platform 110 may also be rotated about their own axes in relative to the supporting platform 110 by changing the position and structure of the driving mechanism. Similarly, in embodiments where the screws are attached to the operating platform and the sleeves are attached to the supporting platform, it is possible to configure the screws to rotate about their own axes in relative to the operating platform, or to configure the sleeves to rotate about their own axes in relative to the supporting platform.

Each screw and sleeve is matched in a one-to-one correspondence manner, so that each screw can match with the corresponding sleeve. Thus, the screw mechanism can have a maximum extending length and a minimum extending length. In the maximum extending length, the threads engaging between the screw and the sleeve are minimized, but still can maintain sufficient connection strength. At this point, most of the screw is located out of the sleeve. In the minimum extending length, the threads engaging between the screw and the sleeve are maximized. At this point, most of the screw is located within the sleeve. In the embodiment of FIG. 1, the length of the threads that engaging between the screw and the sleeve is merely exemplary. In fact, the screw mechanism may be at the minimum extending length or between the minimum extending length and the maximum extending length when the various platforms of the jump elevator are secured in place, respectively.

A plurality of screw mechanisms may be disposed along the perimeter of the supporting platform 110 and the operating platform 120. For example, in one embodiment, the supporting platform 110 and the operating platform 120 have a substantial rectangular or square projection in the vertical direction, and four screw mechanisms are arranged near the corners of the rectangle or square, respectively, such that the supporting platform 110 and the operating platform 120 would obtain substantial uniform stress distribution. In fact, it is possible to arrange one or more screw mechanisms between the supporting platform 110 and the operating platform 120, and each screw mechanism is arranged such that forces can be evenly transferred between the supporting platform 110 and the operating platform 120. Accordingly, the screw mechanism may be substantially arranged in uniform according to the shape of the supporting platform 110 and the operating platform 120.

A plurality of telescopic first pawls 111 and 112 are disposed at a side face of the supporting platform 110, and a plurality of telescopic second pawls 121 and 122 are disposed at the side face of the operating platform 120. Wherein the size and position of each of the first and second pawls are configured to fit with apertures 211, 221, 212, and 222 on the inner wall of the hoistway 210 and 220, such that each of the first and second pawls is moveable into each aperture. Wherein the size of each screw and sleeve is configured such that: at least when the screw mechanism is at the maximum extending length, the supporting platform 110 or the operating platform 120 can be lifted to a height that enables the first pawls or second pawls to fit with apertures at higher position. In the illustrated embodiment, the maximum extending length of the screw mechanism will enable the second pawls 121 and 122 to reach a higher elevation in the illustrated vertical direction and fit with apertures not shown.

To ensure sufficient structural strength, in the illustrated embodiment, a plurality of screw mechanisms are arranged perpendicular to the top surface of the supporting platform 110 and the bottom surface of the operating platform 120. Correspondingly, in other embodiments, the screw mechanism may be arranged perpendicular to the bottom surface of the supporting platform 110 and the top surface of the operating platform 120.

The driving mechanism 300 is shown schematically in FIG. 1. It is readily understood that the driving mechanism 300 may include a motor and a transmission mechanism, wherein the motor selectively extends or retracts the screw mechanism through the transmission mechanism. The motor may be disposed on one of the supporting platform or the operating platform and may also be disposed on other portions of the jump elevator not shown in FIG. 1. The transmission mechanism comprises a belt transmission mechanism, a gear transmission mechanism and/or a rack transmission mechanism and the like. The transmission mechanism is configured to synchronously transmit power provided by the motor to each of the screw mechanisms and cause the plurality of screw mechanisms to extend or retract synchronously. The specific transmission structures and the arrangement thereof may be set according to actual conditions, for example, the motor and transmission mechanism described above may be disposed at the surface of or within certain platform, and may be wired according to actual conditions. The motor may employ conventional AC or DC motor, and may also employ as stepping motor or the like. Compared with hydraulic system, a driving mechanism 300 mainly powered by motor is smaller in size, lighter in weight, lower in cost, higher in operating efficiency and accuracy, and therefore can provide better operation effect.

The invention further provides a jump elevator which comprises the lifting assembly described above. It will be readily understood that in addition to the various platforms described above as well as the structure shown in FIG. 1, the jump elevator further includes a car that is suspended by a tractor via a steel wire rope, and other elevator components that fit with the car.

Based on the lifting assembly and the jump elevator described above, the present application also provides a jumping method for the jump elevator. The jumping method will be described in details hereinafter.

One embodiment of the jumping method for the jump elevator according to the present application includes the following steps: S1: retracting a plurality of pawls of an operating platform from a first set of apertures on the inner wall of a hoistway, so that the operating platform is movable within the hoistway; S2: extending a screw mechanism so as to lift the operating platform to a height that enables the plurality of pawls of the operating platform to fit with a second set of apertures on the inner wall of the hoistway; S3: extending the plurality of pawls of the operating platform and fitting them into the second set of apertures; S4: retracting a plurality of pawls of a supporting platform from a third set of apertures on the inner wall of the hoistway, so that the supporting platform is movable within the hoistway; S5: retracting the screw mechanism so as to lift the supporting platform to a height that enables pawls of the supporting platform to fit with a fourth set of apertures on the inner wall of the hoistway; and S6: extending the pawls of the supporting platform and fitting them into the fourth set of apertures; Wherein he supporting platform is disposed below the operating platform and the screw mechanism is connected between the supporting platform and the operating platform. Thus, the embodiment of the jumping method described above is applicable to the jump elevator as shown in FIG. 1, which may have a similar structure to an existing jump elevator lifted by hydraulic force, but the jump elevator employs the aforementioned lifting assembly with screw mechanism to replace the existing hydraulic lifting device.

In one embodiment of the jumping method for the jump elevator according to the present application, the first set of apertures and the fourth set of apertures are the same set of apertures. Thus, after the jumping method according to the present application is performed, the supporting platform will be lifted to the initial height of the operating platform, and the operating platform is lifted to a higher position.

Another embodiment of the jumping method for the jump elevator according to the present application comprises the steps of: S1: retracting a plurality of pawls of a supporting platform from a first set of apertures on the inner wall of a hoistway, so that the supporting platform is movable within the hoistway; S2: extending a screw mechanism so as to lift the supporting platform to a height that enables the plurality of pawls of the supporting platform to fit with a second set of apertures on the inner wall of the hoistway; S3: extending a plurality of pawls of the supporting platform and fitting them into the second set of apertures; S4: retracting a plurality of pawls of an operating platform from a third set of apertures on the inner wall of the hoistway, so that the operating platform is movable within a hoistway; S5: retracting the screw mechanism so as to lift the operating platform to a height that enables pawls of the operating platform to fit with a fourth set of apertures on the inner wall of the hoistway; and S6: extending pawls of the operating platform and fitting them into the fourth set of apertures; Wherein the operating platform is disposed below the supporting platform and the screw mechanism is connected between the supporting platform and the operating platform. Accordingly, embodiments of the above jumping method are applicable to a jump elevator with the operating platform disposing below the supporting platform as described above. While specific structure of the jump elevator is not shown in the drawings, it will be readily appreciated in view of the above disclosure.

In another embodiment of the jumping method for the jump elevator according to the present application, the first set of apertures and the fourth set of apertures are the same set of apertures. Thus, after the jumping method according to the present application is performed, the operating platform will be lifted to the initial position of the supporting platform and the supporting platform is lifted to a higher position.

In various embodiments described above, the distance between the fourth set of apertures and the third set of apertures in the vertical direction is greater than or equal to the height of a single floor. Therefore, after performing the aforementioned jumping operation, the jump elevator as a whole will be lifted by the height of at least one floor, or optionally lifted by the height of two or more floors, thereby achieving the effect of hoisting the height of the elevator machine room within the hoistway. The jumping method can be performed continuously, and can also be selectively performed after certain time of period. The specific operating interval depends on the actual constructing environment of the building as well as the constructing progress and plan. In fact, according to actual needs, the aforementioned jumping method can be modified to lower the height of the elevator machine room within the hoistway.

The lifting assembly and the jump elevator according to the present application do not require providing pressure vessels, pressure pipelines and the pumping equipment for working fluid, therefore the weight is lowered down and the complexity is reduced, and the potential risk of leakage for working fluid can also be avoided.

This description discloses the application with reference to the accompanying drawings, and also enables those skilled in the art to implement the application, including manufacturing and using any devices or systems, selecting suitable materials, and using any incorporated methods. The scope of the present application is defined by the claimed technical solution and includes other instances that occur to those skilled in the art. It is intended that such other instances are fallen within the protective scope defined by the technical solutions claimed by the present application, as long as such other instances include structural elements that are not different from the literal language of the claimed technical solution, or such other instances contain equivalent structural elements with no substantial differences from the literal language of the claimed technical solution.

What is claimed is:

1. A lifting assembly for a jump elevator comprising:
a supporting platform provided with a plurality of telescopic first pawls at the side face thereof;
at least one screw mechanism comprising a screw and a sleeve, the screw and the sleeve are provided with an external thread and an internal thread matching with each other, respectively;
a driving mechanism configured to drive one of the screw and the sleeve to rotate in relative to the other, such that the screw mechanism extends or retracts;
wherein the screw mechanism is connected between the supporting platform and the operating platform, one of the screw and the sleeve is configured to be rotatably attached to one of the supporting platform or the operating platform.

2. The lifting assembly of claim 1, wherein the other of the screw and the sleeve is configured to be fixed to the other of the supporting platform or the operating platform.

3. The lifting assembly of claim 1, wherein a plurality of screw mechanisms are disposed along the perimeter of the supporting platform and the operating platform.

4. The lifting assembly of claim 1, wherein a plurality of telescopic second pawls are disposed at the side face of the operating platform.

5. The lifting assembly of claim 4, wherein the size and position of the first and second pawls are configured to fit with apertures on the inner wall of a hoistway, such that the first and second pawls are moveable into the apertures.

6. The lifting assembly of claim 5, wherein the screw and the sleeve are sized that at least when the screw mechanism is at maximum extending length, the supporting platform or the operating platform can be lifted to a height that enables the first pawls or the second pawls to fit with apertures at a higher position.

7. The lifting assembly of claim 1, wherein the supporting platform is disposed below the operating platform.

8. The lifting assembly of claim 7, wherein a plurality of screw mechanisms are disposed perpendicular to the top surface of the supporting platform and the bottom surface of the operating platform.

9. The lifting assembly of claim 1, wherein the driving mechanism comprises a motor and a transmission mechanism, wherein the motor selectively extends or retracts the screw mechanism through the transmission mechanism.

10. The lifting assembly of claim 9, wherein the motor is disposed on one of the supporting platform or the operating platform.

11. The lifting assembly of claim 9, wherein the transmission mechanism comprises a belt transmission mechanism, a gear transmission mechanism, and/or a rack transmission mechanism.

12. The lifting assembly of claim 9, wherein the transmission mechanism is configured to cause the plurality of screw mechanisms to extend or retract synchronously.

13. The lifting assembly of claim 1, wherein the operating platform comprises a working platform, a machine room platform, and/or a storage compartment platform.

14. A jump elevator characterized in that it comprises the lifting assembly according to claim 1.

15. A jumping method for a jump elevator comprising:
retracting a plurality of pawls of an operating platform from a first set of apertures on the inner wall of a hoistway, so that the operating platform is movable within the hoistway;
extending a screw mechanism so as to lift the operating platform to a height that enables the plurality of pawls of the operating platform to fit with a second set of apertures on the inner wall of the hoistway;
extending the plurality of pawls of the operating platform and fit them into the second set of apertures;
retracting a plurality of pawls of a supporting platform from a third set of apertures on the inner wall of the hoistway, so that the supporting platform is movable within the hoistway;
retracting the screw mechanism so as to lift the supporting platform to a height that enables pawls of the supporting platform to fit with a fourth set of apertures on the inner wall of the hoistway; and
extending the pawls of the supporting platform and fitting them into the fourth set of apertures;
wherein the supporting platform is disposed below the operating platform, and the screw mechanism is connected between the supporting platform and the operating platform.

16. The jumping method of claim 15, wherein the first set of apertures and the fourth set of apertures are the same set of apertures.

17. The jumping method of claim 15, wherein the distance between the fourth set of apertures and the third set of apertures in the vertical direction is greater than or equal to the height of a single floor.

18. A jumping method for a jump elevator comprising:
retracting a plurality of pawls of a supporting platform from a first set of apertures on the inner wall of a hoistway, so that the supporting platform is movable within the hoistway;
extending a screw mechanism so as to lift the supporting platform to a height that enables a plurality of pawls of the supporting platform to fit with a second set of apertures on the inner wall of the hoistway;
extending the plurality of pawls of the supporting platform and fitting them into the second set of apertures;
retracting a plurality of pawls of an operating platform from a third set of apertures on the inner wall of the hoistway, so that the operating platform is movable within the hoistway;
retracting the screw mechanism so as to lift the operating platform to a height that enables pawls of the operating platform to fit with a fourth set of apertures on the inner wall of the hoistway; and
extending pawls of the operating platform and fitting them into the fourth set of apertures;
wherein the operating platform is disposed below the supporting platform and the screw mechanism is connected between the supporting platform and the operating platform.

19. The jumping method of claim 18, wherein the first set of apertures and the fourth set of apertures are the same set of apertures.

20. The jumping method of claim 18, wherein the distance between the fourth set of apertures and the third set of apertures in the vertical direction is greater than or equal to the height of a single floor.
